(19) United States
(12) Patent Application Publication
(10) Pub. No.: US 2025/0192490 A1
(43) Pub. Date: Jun. 12, 2025

(54) BUSBAR SYSTEM

(71) Applicant: Future Systems Besitz GmbH, Roedental (DE)

(72) Inventors: Peter SPIEL, Regensburg (DE); Sebastian STOLL, Coburg (DE); Christian ZIMMERMANN, Leutenbach (DE); Bernhard FOERST, Kronach (DE)

(21) Appl. No.: 19/053,068

(22) Filed: Feb. 13, 2025

Related U.S. Application Data
(63) Continuation of application No. PCT/EP2023/079689, filed on Oct. 24, 2023.

(51) Int. Cl. H01R 25/14; H01R 24/64; H02B 1/21

(52) U.S. Cl. CPC H01R 25/142; H01R 24/64; H01R 25/147; H02B 1/21; H01R 2201/04

(57) ABSTRACT

A busbar system for a switching cabinet has at least two first busbars, each of the two busbars extending along a predetermined first direction, having a first surface extending in the predetermined first direction, and being adapted for carrying low voltage current. The two first busbars provide, on the first surface along the predetermined first direction, electrical connection points for devices placed in the switching cabinet, and are connectable with a low-voltage current source.

### CROSS REFERENCE TO RELATED APPLICATIONS

This application is a continuation of International Application No. PCT/EP2023/079689, filed Oct. 24, 2023, the entire contents of which are incorporated by reference herein.

### FIELD OF THE INVENTION

The present invention relates to a busbar system for a switching cabinet, as well as to a bus device adapted to be connected to the busbar system and to a switching cabinet-internal communication system.

BACKGROUND

Busbar systems for switching cabinets are widely known. Such busbar systems are used in power installations and comprise at least two busbars which distribute electrical power to electrical installation devices placed on and connected to the busbars. Busbars as well as the electrical installation devices as well as low voltage devices are usually completely enclosed by the switching cabinet.

If an electrical device has data processing and communication capabilities, it is usually connected with another device via a data transmission line. This data transmission line usually forms within the switching cabinet a point-to point connection distinct from the busbar system. The same applies for the low voltage power supply of the data processing devices or parts of devices in the switching cabinet. Such low voltage power is also provided or distributed to the devices via separate point-to-point connections within the switching cabinet.

If there are many electrical devices to be connected in this way, the low-voltage and/or communication wiring in the switching cabinet becomes very complex, and service or modification of the installation during lifetime of the switching cabinet may become complicated tasks.

Therefore, there is a need to provide means which alleviate this drawback.

### SUMMARY

This object may be solved by device with features described in this disclosure.

Accordingly, provided is a busbar system for a switching cabinet, comprising: at least two first busbars, each of the at least two busbars extending along a predetermined first direction, having a first surface extending in the predetermined first direction, and being adapted for carrying low voltage current; the at least two first busbars providing, on the first surface along the predetermined first direction, electrical connection points for devices placed in the switching cabinet, and being connectable with a low-voltage current source.

The electrical installation device or electrical component may be one of the following: Engine control unit, power supply unit, connector for electrical devices, measuring device, display device, converter unit, fuse holder, switch disconnector, switch disconnector with fuses, fuse switch disconnector, overvoltage protection device, lightning protection device, communication device, residual current circuit breaker, interference suppression device, controller, or in general, equipment for automation purposes.

### BRIEF DESCRIPTION OF THE DRAWING

The invention and embodiments thereof are described in more detail in connection with the drawings, in which

FIGS. 1A-C illustrate a busbar system according to the invention;

FIGS. 2A-B illustrate a busbar system with electrical installation devices according to an embodiment of the invention;

FIG. 3 illustrates a busbar system with bus devices and electrical

installation devices according to a further embodiment of the invention;

FIGS. 4A-E illustrate several bus devices according to embodiments of the invention in more detail.

### DETAILED DESCRIPTION

In the following, “up”, “down”, “horizontal”, “vertical”, “in front of”, “behind” relate to orientations of one or more parts perceived by a human looking directly at those parts when they are mounted as intended.

For illustration purposes only, it is assumed that busbars of the busbar system run or extend in a first direction x, which is the horizontal direction. Then, the second direction, denoted here by y, is perpendicular to the first direction, is the vertical direction. The busbars are mounted, or intended to be mounted, at a vertical wall or surface enclosed by a switchboard cabinet.

It should be understood that the x and y directions may, e.g., be reversed. That is, the busbars may then run in the vertical direction.

Several busbars, as parts of a busbar system, run in parallel to each other. The busbars may conduct high-voltage currents, e.g., 3 AC phases with more than 60VDC, or 25VAC, typically with about of 400 VAC. These figures are only examples.

Electrical installation devices 200 may cover at least one busbar 20, usually all the high-voltage busbars 20 of the busbar system and connect to them. The busbar connector may extend in the vertical direction y which may also be denoted as the longitudinal direction of the electrical installation device or part thereof.

The front or frontside of the installation device, of the busbar system or of any part thereof is the side which is oriented to a human person standing in front of the of the electrical installation device, busbar system or the part if they are mounted as intended.

The rear side is a side of a part which is oriented or faced to the background or away from a human standing in front of that part.

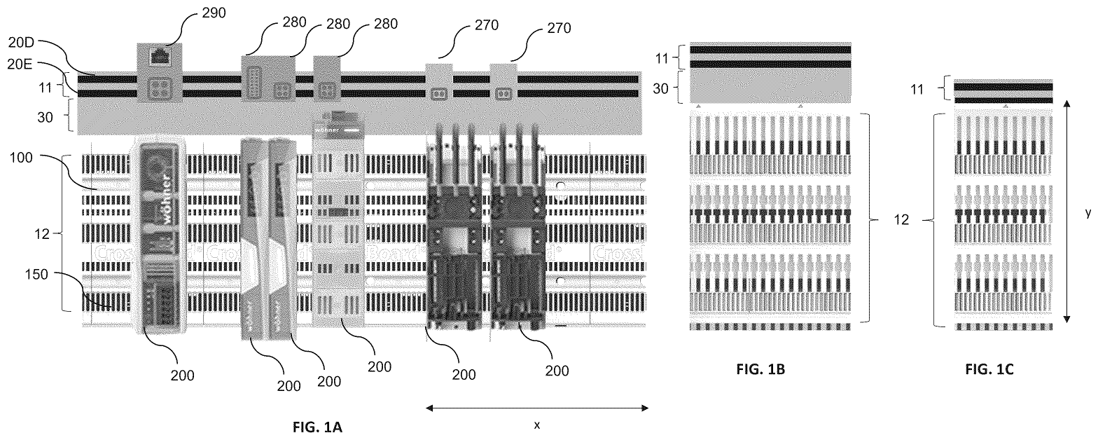

FIGS. 1A, 1B, and 1C illustrate three examples of a busbar system according to an embodiment of the invention. The busbar system is designed to be received in, or enclosed by, a switching cabinet. The busbar system comprises two first busbars 20D, 20E. Each of the two first busbars 20D, 20E extends along a predetermined first direction x. The first busbars 20D, 20E are adapted to carry low voltage current and power as well as communication signals.

The busbar system further comprises three second busbars 20. They are covered by a touch protection cover 100, and are therefore not visible in FIGS. 1A-C. Each of the at least two second busbars 20 has a second surface 22 (not visible in FIGS. 1A-C) extending in the first direction x and providing, on the second surface 22, electrical connection points along the first direction x for electrical installation devices 200 placed in the switching cabinet. The second busbars 20 are adapted for providing or distributing high voltage power over their second surfaces 22.

The two first busbars 20D, 20E are arranged in a contiguous first area 11, and the three second busbars 20 are arranged in a second area 12 which is distinct from the first area 11. The second area 12 is here also contiguous.

The first area 11 may be spaced apart from the second area 12 in the second direction y by a predefined space 30, as can be seen in configuration a and in configuration b.

However, the contiguous first area 11 can be immediately adjacent to the second area 12 with no space left when limited space is an issue, as illustrates in FIG. 1C.

Each of the two first busbars 20D, 20E has a first surface 21 also extending in the first direction x. They are adapted for distributing low voltage current, most likely but not limited to 24VDC (auxiliary power supply) to devices 200 arranged in the switching cabinet via their first surfacers 21. Hereto, the two first busbars 20D, 20E provide, on their first surface 21 along the first direction x, electrical connection points for electrical connectors 270 or other bus devices 260 placed in the switching cabinet. That is, connectors 270 can be plugged onto the busbars 20D, 20E at any position along the first direction x. The connectors in turn are connected via wiring to the electrical installation devices 200 connected to the high-voltage busbars 20 placed below the respective connectors 270 or other bus devices 260.

The low voltage current is provided by a low voltage current source connected to the two first busbars 20D, 20E. The current source may also be connected to the busbars as a bus device 260.

As already indicated above, the busbar system further comprises at least two, typically three, second busbars 20, each of which having a second surface 22 extending in the first direction x. They are adapted for distributing high voltage power (e.g., 400VAC or more) over their respective second surfaces 22. The busbars 20 are covered by the protection cover 100 against being touched by users. Electrical installation devices 200 may be attached at and connected to the busbars 20 through opening slits 150 provided in the protection cover 100.

The first busbars 20D, 20E are typically shaped differently from the second busbars 20. While the first busbars 20D, 20E are typically made from copper, the second busbars 20 are typically made from steel. The first busbars may be u-shaped profile rails or thin, flat bars while the second busbars 20 are typically shaped as flat, thick bars.

The predefined space 30 may be advantageous for electro-magnetic compatibility reasons. Most preferably, the low voltage busbars 20D, 20E are arranged above the upper edge (as illustrated) or below or lower edge of the second area 12. The space 30 may be sized depending on the needs of the electromagnetic compatibility. The larger the voltages carried by the high-voltage busbars 20, the larger the space 30 may be chosen.

If the contiguous first area 11 is not only adjacent to the second area 12 but also spaced apart from the second area 12 in a second direction y which is perpendicular to the first direction x, the space 30 may form a cooling channel for the devices 200 placed on the busbars.

The busbar system may further comprise fan means 35 for conveying air through the cooling channel 30.

Another usage of the space 30 is to implement a lighting system to ease servicing the switching cabinet. It is advantageous to use a specific material for the proposed busbar system housing which acts as a light guide to provide homogeneous light emission.

In another variant, the busbar elements are provided as modular sub-modules with an electrical and mechanical interconnection possibility. This allows one to cover different switching cabinet widths with a modular approach.

The at least two first busbars 20D, 20E may be further adapted for carrying communication signals. The communication signals can be modulated onto low voltage current. Then, no additional separate low voltage busbars for the communication signal are needed. This variant is most cost-effective busbar variant.

For connecting electrical installation devices 200 to the first busbars 20D, 20E, the first busbars are adapted for receiving bus devices 260, 270, 280, 290, e.g., plugs 270, or pluggable connectors 280, or gateways, which in turn are connected via wiring to the electrical installation devices 200. The bus devices may be clamped onto the busbars 20D, 20E. Depending on the variants of the busbars 20D, 20E, the bus devices 260, 270, 280, 290 may be pluggable power supply connectors 270 and/or pluggable communication signal connectors 280, 290.

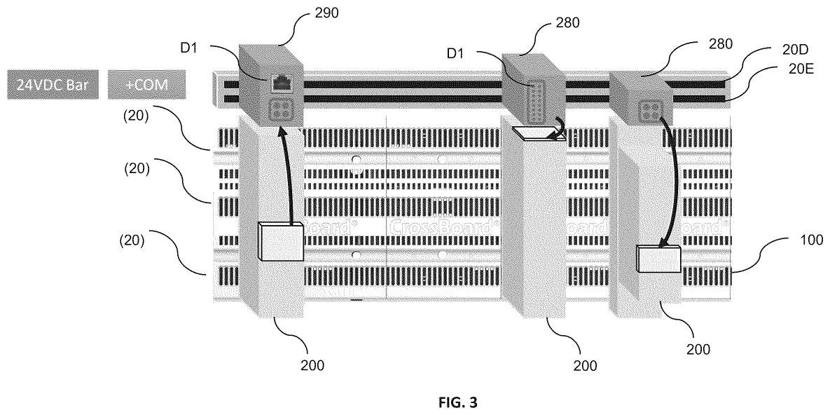

FIG. 3 illustrates the several variants of the bus devices 260, which are embodied as simple current plugs 270 for just connecting to low-voltage current busbars, or connectors 280 and gateways 290 for connecting to a combined low-voltage power (e.g., 24VDC) and/or communication signals (COM) carrying pair of busbars 20D, 20E.

The connector 270 provides an RJ45 socket 261 for a communication line, and a low-voltage power supply plug 262. It can implement a gateway to a connecting a PLC (programmable logic controller).

The connector 280 provides a combined COM and power supply socket 262, e.g., compatible with Motus C14, OMUS, Eques devices.

Connector 270 provides as mentioned above, just a low voltage power supply socket.

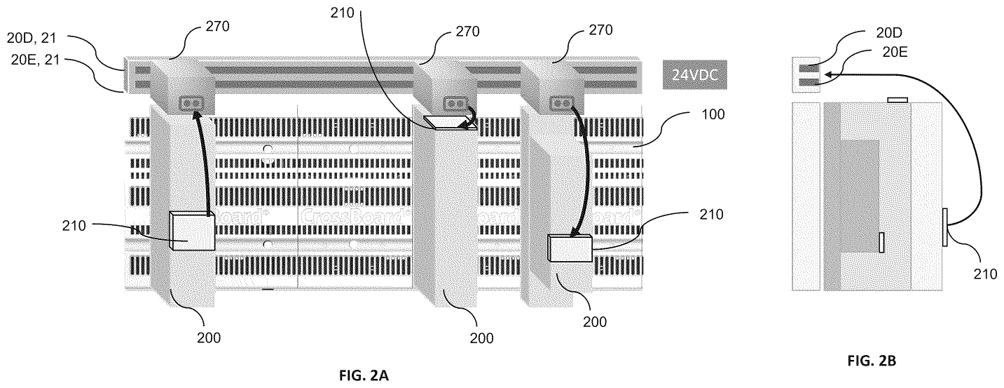

As also mentioned above, the low voltage power and/or communication signals may be provided to electrical installation devices 200 arranged on the second busbars 20 below the bus devices, i.e., plugs 270, connectors 280, gateways 290. That is, each electrical installation device 200 may have its own one bus device associated thereto which provides connection to the first busbars 20D, 20E. Each electrical installation device 200 may have an interface 210 with the same connector plugs as the respective connectors, as shown in FIGS. 2A and 2B.

The bus devices 260 may be integrated into more complex devices which provide further functionality.

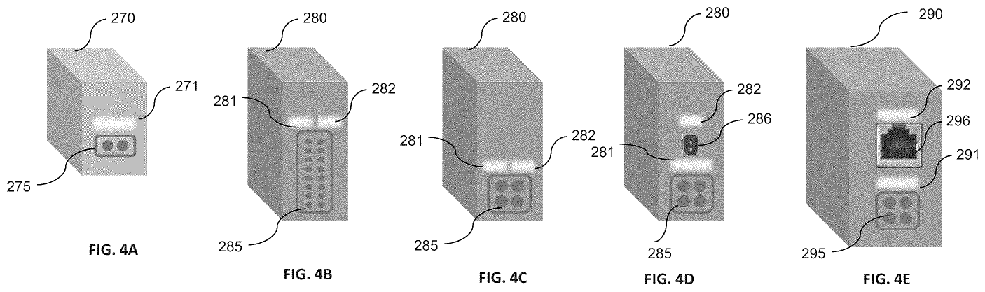

FIGS. 4A-E illustrate several bus devices 270, 280, 290 in more detail. Bus device 270 in FIG. 4A is the simple low-voltage current supply. It provides a plug 275 for deriving the current from the busbar 20D, 20E. An LED 271 is present for signaling status and overload of the power supply.

Bus devices 280, shown in FIGS. 4B-D, are combined current and communication connectors. They may have a combined current and communication interface plug 285 and an LED 281 for the status and overload of the power supply, and an LED 282 for the communication interface, signaling, e.g., SPE, IO, IO-link. In a variant thereof, the connector 280 has a separate communication interface plug 286.

Bus device 290, shown in FIG. 4E, is a communication gateway providing more functionalities than the bus devices 270, 280 described before. It provides analysis of the communication connection over the busbars 20D, 20E. It has a low-voltage current supply 295, and a communication interface 296, here an RJ45 plug, as well as respective status LEDs 291, 292. LED 291 signals the status of the low-voltage supply as above, and LED 292 signals the status of the communication to the PLC (status, traffic).

In another variant of the busbar system, two pairs of first busbars 20D, 20E are provided, one pair thereof is adapted for distributing the low voltage power over the surface, and the other pair is adapted for carrying the communication signals. This variant provides best noise suppression.

In yet a further embodiment, the busbar system further comprises a touch protection device covering at least the second busbars 20 and the cooling channel 30.

The busbar system may be further adapted for implementing a data bus between a bus controller device 250 and at least one bus device 250 arranged in the switching cabinet, wherein the data bus supports at least one of the following protocols: Ethernet, in particular 10Base T1S Ethernet or Single Pair Ethernet, SPE.

All the bus devices 260, 270, 280, 290 described above attaching means 265 for attaching them to the at least two first busbars 20D, 20E of the busbar system in the switching cabinet. The bus devices may be adapted for supporting at least one of the data bus protocols mentioned above.

The gateway 290 is adapted to translate signals according to one protocol to signals according to another protocol. Typical examples are from Standard Ethernet to 10BaseT1-S, or from 10BaseT1-S to Bluetooth/NFC or WiFi, and vice versa.

The bus devices 280, 290 may be adapted for internal communication with synchronous requests.

Further embodiments of the bus device 260 are derived by using the same connection and communication backend towards the busbar system, but the interface to the application devices is modified.

Variants/functions are:
1. Individual addressable and read/writeable analog or digital Inputs/Ouputs
2. Programmable current limitation and electronic on/off for feeder devices which supply power the low voltage to the busbar system
3. Programmable current limitation and electronic on/off for outlet devices which supply power to external application devices from the low voltage busbar system.

Yet further, embodiments of the invention provide a switching cabinet-internal communication system, comprising: a busbar system as described above, at least one bus device 260 as described above, and a switching cabinet controller 250.

The switching cabinet-internal communication system is adapted for bidirectionally connecting to the bus devices 260, and for transmitting data signals between a connector 280 to the gateway 290. The data flow is bidirectional.

The switching cabinet-internal communication system may be enabled to transfer data asynchronously from an electrical installation device 200 to the gateway 290.

The switching cabinet-internal communication system is also adapted to transfer synchronous messages from the gateway to the connector for sending device configuration data.

The switching cabinet-internal communication system may further comprise a device discovery mechanism for detecting compatible available bus devices connected to the system.

Herein, the device discovery mechanism is adapted for collecting, for each detected device, at least one of the following information items:
device type
device location
functional tags
location tags
vendor name
vendor ID
technical specifications.

The switching cabinet-internal communication system may provide a

keep-alive mechanism for determining that the detected bus devices 260 are still available.

Each bus device 260 may have a unique ID for allowing the device 260 to

be detected, addressed and identified over the bus.

For ease of use, all information about detected bus participants is provided in addition to a GUI tool running on a smartphone or on a PC. This can be realized by using a wired or wireless gateway connected to the communication system.

The internal communication system comprises a configuration possibility for flexible assignment of connector GPIOs to device specific functionalities.

The internal communication is further adapted for encapsulating device functionalities from specific connector signals/IOs.

As described above, the bus devices 260 may have the following functionalities. As a basic functionality, it is a busbar participant. It may be compliant with the 10Base-T1S or SPE (Single Pair Ethernet) standard.

Moreover, it may provide voltage level diagnostics, i.e., it may be adapted for checking health state of the devices connected to the bus.

According to one variant, the bus device provides digital inputs/outputs. Then, it is a multi-connector for e.g., third-party products.

Instead or additionally, the bus device may provide analog inputs/outputs. Specifically, those bus devices may implement current sensors. In a variant, they may additionally provide a measurement amplifier for the measurements provided by the current sensors. By providing processing resources close to the locations where the measurements take place, the length of measurement wirings and/or the amount of data to be transferred may be reduced.

Bus devices may further provide communication protocol gateways or repeater functionalities, for example they may be adapted for scanning connector or connector devices attached to the busbar system. They may store the configuration of the connector or connector devices.

As further functionalities, the bus device may function as a repeater for wireless communication with other devices installed in the switching cabinet, or with users. This functionality may comprise wireless sending and receiving (e.g., WLAN, Bluetooth, NFC) for interconnection between products or to mobile devices/apps, integration of any arbitrary electrical installation devices. The bus devices may provide communication under different communication protocols, or be translators between one connecting standard and another one, (e.g., from one standard Cat5 cable to the busbars like Combar and vice versa).

The bus device may comprise a display or other optical control elements.

They may communicate with mobile devices.

In a further variant, several redundant communication paths may be supported in order to provide a higher availability of the bus device.

A further variant provides features like cooling elements, e.g., a low voltage fan. It may be adapted for using dead space in the switching cabinet.

Further, actuators may be implemented, like motors, air, connectors to sensors. The sensors may comprise sensors acquiring the exact position of electrical installation devices in the switching cabinet.

For housekeeping and management functionalities, local processing power may be provided. It may be used to scan the connector or connector devices attached to it. Further, it may be used to store the configuration of the attached connector or connector devices.

Yet further, software/firmware installation and update functionalities from remote sites onto the bus device may be provided.

The bus device may provide an USB interface to an application device.

The bus device may further provide and control software/firmware upgrades or updates to application devices.

Further device variants provide low voltage power management functionalities. A bus device may be configured as a power supply feeder to the low voltage busbars. That is, the bus device provides the low voltage to other devices connected to the bus. Such power supply bus device may further provide voltage and current measurement as well as power switching functions for switching off bus power if no power is needed. Moreover, power saving features may be provided (GreenMode functionality).

Further, bus devices may function as power supply outlets for providing low voltage power to consuming devices connected to those bus devices. Those bus devices deliver power fed via the low voltage bus. In order to protect the low voltage bus against overcharge, an electronic fuse function may be provided. This functionality watches the power consumption of the device attached to and fed by the power supply outlet, and disconnects it in case of a failure of the consuming device such as short circuit.

Yet further, a bus device may be adapted for providing local USV functionality to the low voltage bus and the bus device. USV functionality includes providing back up power to the devices, as well as disconnecting them from the bus or controlling to shut down particular devices or functionalities of devices in case of a power failure. Hereto, communication with all attached low voltage power feeding bus devices and outlet bus devices are advantageous.

What is claimed is:

1. A bus device for a busbar system which is adapted to be enclosed in a switching cabinet, the busbar system comprising:
at least two first busbars, each of the at least two busbars extending along a predetermined first direction, having a first surface extending in the predetermined first direction, and being adapted for carrying low voltage current;
the at least two first busbars providing, on the first surface along the predetermined first direction, electrical connection points for electrical installation devices enclosed in the switching cabinet, and being connectable with a low-voltage current source, the at least two first busbars further being adapted for carrying communication signals,
further comprising at least two second busbars, each of the at least two second busbars having a second surface extending in the predetermined first direction and providing, on the second surface, electrical connection points along the predetermined first direction for electrical installation devices placed in the switching cabinet, and being adapted for distributing high voltage power over the second surface,
the bus device comprising:
a connector for connecting with the at least two first busbars of the busbar system,
attaching means for attaching the bus device to the at least two first busbars,
the bus device being connectable with an electrical installation device for providing low voltage power and/or communication signals to the electrical installation device to which it is associated.

2. The bus device of claim 1 being embodied as pluggable power supply connectors and/or pluggable signal connectors.

3. The bus device of claim 1 being embodied as a gateway between the at least two first busbars and one of the electrical installation devices enclosed in the switching cabinet.

4. The bus device of claim 1 being adapted for supporting at least one of the following data bus protocols:
Ethernet, in particular 10Base TIS Ethernet, or Single Pair Ethernet, SPE.

5. The bus device of claim 1 further being adapted for internal communication with synchronous requests.

6. The bus device of claim 1 further comprising a unique ID for allowing the bus device to be detected addressed and identified over the bus.

7. The bus device of claim 1 further being adapted for checking health state of installation devices connected to the bus.

8. The bus device of claim 1 further comprising a sensor for acquiring position of the electrical installation device enclosed in the switching cabinet.

9. A switching cabinet-internal communication system, comprising a busbar system, the busbar system comprising:
at least two first busbars, each of the at least two busbars extending along a predetermined first direction, having a first surface extending in the predetermined first direction, and being adapted for carrying low voltage current;
the at least two first busbars providing, on the first surface along the predetermined first direction, electrical connection points for electrical installation devices enclosed in the switching cabinet, and being connectable with a low-voltage current source, the at least two first busbars further being adapted for carrying communication signals, further comprising at least two second busbars, each of the at least two second busbars having a second surface extending in the predetermined first direction and providing, on the second surface, electrical connection points along the predetermined first direction for electrical installation devices placed in the switching cabinet, and being adapted for distributing high voltage power over the second surface;
at least one bus device, the bus device comprising a connector for connecting with the at least two first busbars,
attaching means for attaching the bus device to the at least two first busbars, the bus device being connectable with an electrical installation device for providing low voltage power and/or communication signals to the electrical installation device to which it is associated
a switching cabinet controller;
further comprising a device discovery mechanism for detecting compatible available bus devices connected to the system, wherein the device discovery mechanism is adapted for collecting, for each detected bus device, at least one of the following information items:
device type;
device location;
functional tags;
location tags;
vendor name;
vendor ID; and
technical specifications.

10. The switching cabinet-internal communication system of claim 9, the switching cabinet-internal communication system being further adapted for connecting to the at least one bus device, and for transmitting data signals from a connector to a gateway.

11. The switching cabinet-internal communication system of claim 10, wherein the internal communication system is adapted to transfer synchronous requests from a gateway to a connector for receiving device information.

12. The switching cabinet-internal communication system of claim 9, wherein the internal communication system is adapted to transfer synchronous messages from the gateway to the connector for sending device configuration data.

13. The switching cabinet-internal communication system of claim 9, wherein the internal communication system provides a keep-alive mechanism for determining that the detected bus devices are still available.

14. The switching cabinet-internal communication system of claim 9, wherein each bus device has a unique ID for allowing the device to be addressed and identified over the bus.

15. The switching cabinet-internal communication system of claim 9, wherein the internal communication system comprises a configuration possibility for flexible assignment of connector GPIOs to device specific functionalities.

16. The switching cabinet-internal communication system of claim 9, further adapted for encapsulating device functionalities from specific connector signals/IOs.
